(19) United States
(12) Patent Application Publication
(10) Pub. No.: US 2007/0107670 A1
(43) Pub. Date: May 17, 2007

(54) PET COLLAR TO REDUCE SHEDDING

(76) Inventors: Joseph Pampena, North York, ON (CA); Lou Sirianni, Etobicoke, ON (CA); John Sacchetti, Etobicoke, ON (CA)

Correspondence Address: FASTH LAW OFFICES (ROLF FASTH), 26 PINECREST PLAZA, SUITE 2, SOUTHERN PINES, NC, 28387-4301, US

(21) Appl. No.: 11/464,715

(22) Filed: Aug. 15, 2006

Related U.S. Application Data
(60) Provisional application No. 60/707,976, filed on Aug. 15, 2005.

(51) Int. Cl. A01K 27/00

(52) U.S. Cl. 119/858

(57) ABSTRACT

The present invention provides an apparatus for reducing shedding in pets. The apparatus comprises a collar of adjustable length to fit around the neck of a pet and two or more magnets fitted on the collar. The magnets are fitted so that their position can be adjusted as the length of the collar is adjusted. Each magnet has its poles aligned and directed towards the jugular vein in the neck of the pet. Further, the magnetic field produced is sufficient to reduce shedding in pets by increasing the circulation of the animal. Preferably, the magnetic field strength for each magnet is in the range of 12,500 gauss.

### FIELD OF THE INVENTION

The present invention relates to an apparatus to reduce shedding in some pets such as dogs and cats. In particular the present invention provides a pet collar containing magnets to reduce shedding and improve circulation in the animal.

### BACKGROUND OF THE INVENTION

It is well known that most breeds of dogs and cats are prone to shedding. When such breeds are kept as pets inside a home, cleaning up the hairs shed by the animals can become a tiresome chore for the pet owner. While regular coat brushing and grooming of the household pet is often recommended as a way to reduce shedding around the home, the brushing itself can become a tedious chore for the pet owner. Therefore, it is worthwhile to explore alternative ways to reduce shedding in household pets such that the requirement for cleaning the home and brushing and grooming the pet is reduced.

### SUMMARY OF THE INVENTION

An object of the present invention is to provide a means to reduce shedding in pets such as cats and dogs.

A further object of the present invention is to provide a pet collar containing two or more magnets where the magnets are in close proximity to the jugular vein of the pet when worn.

A still further object of the present invention is to provide a pet collar where the position of the magnets may be adjusted as the collar size is adjusted.

Accordingly the present invention provides an apparatus for reducing shedding in pets. The apparatus comprises a collar of adjustable length to fit around the neck of a pet and two or more magnets fitted on the collar. The magnets are preferably fitted so that their position can be adjusted as the length of the collar is adjusted. Each magnet has its poles aligned and directed towards the jugular vein in the neck of the pet. Further, the magnetic field produced is sufficient to reduce shedding in pets by increasing the circulation of the animal. Preferably, the magnetic field strength for each magnet is in the range of 12,500 gauss.

### BRIEF DESCRIPTION OF DRAWINGS

For a better understanding of the present invention, and to show more clearly how it may be carried into effect, reference will now be made, by way of example, to the accompanying drawings which show a preferred embodiment of the present invention.

FIG. 1 shows a perspective view of a preferred embodiment of a pet collar according to the present invention;

FIG. 2 shows a top view of the preferred embodiment of FIG. 1; and

FIG. 3 shows a corresponding bottom view of the preferred embodiment of FIG. 1.

### DETAILED DESCRIPTION OF THE INVENTION

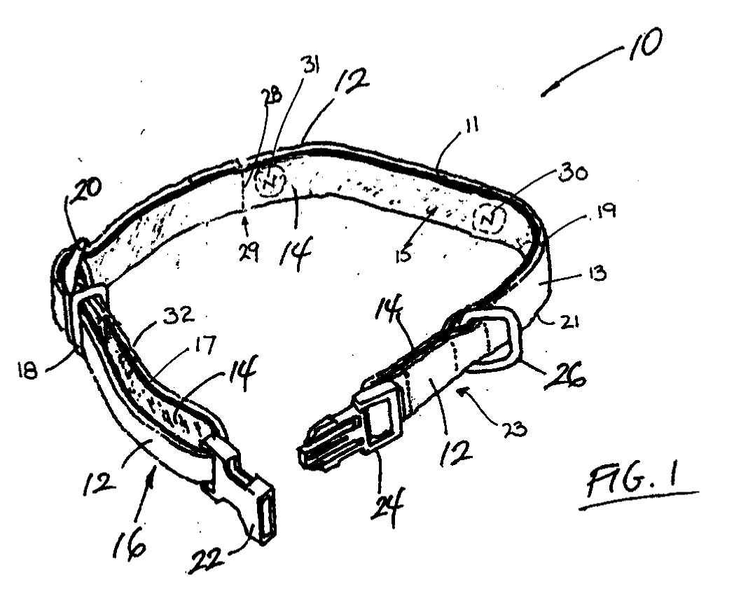

Referring to FIGS. 1-3, a preferred embodiment of a pet collar is generally indicated by reference numeral 10. As shown, the collar 10 has two or more magnets, and preferably three as shown, 30, 31, 32 fitted into the collar 10, preferably equi-spaced along the length of the collar 10. As shown, all of the magnets 30, 31, 32 have their poles aligned and facing the inside of the collar 10 (shown in FIG. 3) so that the polarity of the magnets 30, 31, 32 are directed towards the neck of the pet's jugular veins when the collar 10 is worn by the pet. The pet is typically a dog or a cat.

The magnets 30, 31, 32 are preferably of high strength, in the range of 5,000 to 15,000 gauss (preferably 12,500 gauss) sufficient to reduce shedding in pets by increasing the circulation of the animal. Magnetic field strengths below this range are not sufficiently effective. As an example, and not to limit the scope of the invention, the magnets 30, 31, 32 are nickel magnets with chrome plating which have high field strength characteristics and greater resistance to demagnetization and corrosion as compared to traditional types of magnets. Still referring to FIGS. 1-3, the collar 10 comprises a length of an outer strap 12 having an inner side 11, outer side 13, first side edge 19 and second side edge 21 and a liner 14 provided on the inner side 11 of the strap 12. The outer strap 12 and the liner 14 may be fastened together by stitching along the first edge 19 and second side edge 21 of outer strap 12, or by any other suitable means. By way of example, and not to restrict the scope of the invention, the outer strap 12 may be of woven nylon material to provide strength and resistance to wear. The outer strap can also be made from leather or a combination of suitable materials, such as, for example, leather and nylon. The liner 14 may be made of felt or cotton, or any similar material to provide a soft layer for the pet's comfort. Stitching has been found to be a cost effective way of fastening these materials together.

The collar 10, in the embodiment shown, is provided with means to adjust its length to fit different sizes of pets. In the embodiment shown, collar 10 includes a releasable fastener adapted to releasably join each end of the collar 10 together. In the preferred embodiment, the releasable fastener comprises a two-piece interlocking plastic buckle 22,24. At least one of the pieces 22 is adapted to slideably receive a looped end 16 of the collar 10. In known manner, by threading a short length of the loop 16 through a loop buckle 20, the size of the loop 16 can be adjusted to facilitate the length-adjustment of the collar 10. A sliding ring 18 is provided to hold the looped end 16 together. Optionally, to connect the collar 10 to a leash (not shown), a second fixed ring 26 is provided.

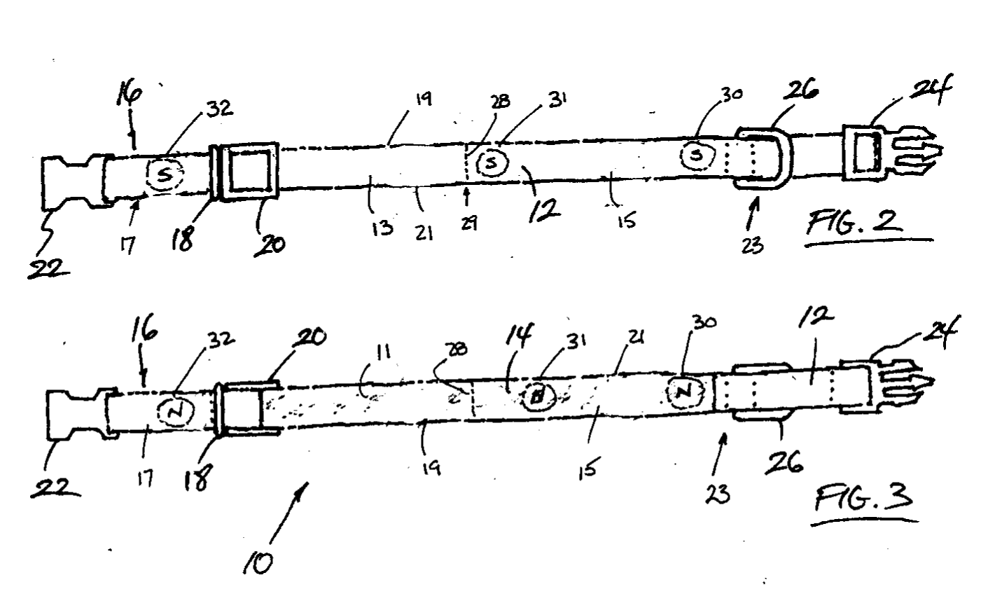

As explained above, the magnets 30, 31, 32 are distributed at intervals along the length of the collar 10. In the preferred embodiment shown in FIGS. 1-3, each magnet 30, 31, 32 is fitted between the outer strap 12 and the liner 14. A first magnet 30 is located adjacent one end 23 of the collar 10 and preferably positioned so that the magnet 30 is able to be moved within a first pocket 15 formed between the liner 14 and outer strap 12. A seam 28 is located at about the mid point 29 of the outer strap 12 and liner 14 to define one end of the first pocket 15 and movement of magnet 30 in one direction. The position of fixed ring 26 defines the other end of pocket 15 and movement of magnet 30 in the other direction. A second magnet 31 is positioned within the first pocket 15 formed between the liner 14 and outer strap 12 and is typically positioned adjacent seam 28. The third magnet 32 is located within the loop end 16 of the collar 10 remote from the first magnet 30 and positioned so that the magnet 32 is able to be moved within a second pocket 17 formed between the liner 14 and outer strap 12. The position of loop buckle 20 defines the one end of pocket 17 and movement of magnet 32 in one direction. Buckle piece 22 defines the other end of the second pocket 17 and movement of magnet 32 in the other direction. As loop end 16 is increased magnet 32 is moved within the second pocket 17 closer to buckle piece 22. If the magnets 30, 31, 32 are fixed in position, as the length of collar 10 is adjusted the magnets will not be positioned near the pet's jugular vein and the effectiveness will be reduced. In addition, if the position of the magnets is fixed it may be difficult to provide as wide a range of adjustment. By making the position of the magnets adjustable when the length of the collar is adjusted the effectiveness is maintained as magnets 30, 31, 32 are always positioned to be adjacent the jugular vein of the pet. As shown in FIGS. 2 and 3, the magnets 30, 31, 32 are distributed at intervals such that when the collar 10 is worn around the neck of a pet, the magnets 30, 31, 32 one or more of the magnets will be adjacent the jugular vein of the pet even if the collar rotates on the neck of the pet. Three magnets are shown in the preferred embodiment by way of example only, and it is not intended that the apparatus of the present invention be limited to three magnets. Rather, it has been found that three magnets arranged in the manner shown are sufficient for the intended purpose of the present invention.

Although the invention has been described and illustrated with reference to a preferred embodiment, those skilled in the art will appreciate that the invention may be otherwise embodied within the scope of the following claims.

1. An apparatus for reducing shedding in pets, said apparatus comprises a collar of adjustable length to fit around the neck of a pet and two or more magnets fitted on the collar wherein the magnets are fitted so that their position can be adjusted as the length of the collar is adjusted, each magnet has its poles aligned and directed towards the jugular vein in the neck of the pet and the magnetic field produced is sufficient to reduce shedding in pets by increasing circulation in the pet.

2. An apparatus according to claim and having three magnets fitted on said collar.

3. An apparatus according to claim 1 wherein each magnet has a magnetic field strength of 12,500 gauss.

4. An apparatus according to claim 1 wherein each magnet is coated for improved durability, resistance to demagnetization and corrosion.

5. An apparatus according to claim 4 wherein each magnet is made of nickel and is chrome plated.

6. An apparatus according to any one of claims 1, wherein the collar comprises a length of an outer strap having an inner side, an outer side a first side edge and a second side edge and a liner provided on the inner side of the outer strap and the outer strap and the liner are fastened together along the first and second side edges of the outer strap and at least one seam across a width of the outer strap to form at least two pockets in which the magnets are positioned.

7. An apparatus according to any one of claims 1, wherein said pet is selected from the group consisting of a dog and a cat.

8. An apparatus for reducing shedding in pets, said apparatus comprises a collar adapted to fit around the neck of a pet and two or more magnets fitted on the collar wherein each magnet has its poles aligned and directed towards the jugular vein in the neck of the pet and a magnetic field strength of between 5,000 and 15,000 gauss.

9. An apparatus according to claim 8 wherein each magnet has a magnetic field strength of 12,500 gauss.

10. An apparatus according to claim 8, wherein said collar is of adjustable length and the magnets are fitted so that their position can be adjusted as the length of the collar is adjusted.
